(19) United States
(12) Patent Application Publication
(10) Pub. No.: US 2003/0066480 A1
(43) Pub. Date: Apr. 10, 2003

(54) Disc painting machine for painting various discs

(76) Inventor: Jen Show Hsieh, Chong Ho City (TW)

Correspondence Address: Jen Show Hsieh, P.O. Box 10-69, Chong Ho, Taipei, 235, TW

(21) Appl. No.: 09/972,657

(22) Filed: Oct. 9, 2001

(51) Int. Cl. B05C 1/00

(52) U.S. Cl. 118/209; 118/230

(57) ABSTRACT

A disc painting machine includes one or more holder devices supported on rotary platform and a rotary board and each having a plate for supporting the discs to be painted. The plates each has a number of orifices for vacuuming purposes and for firmly drawing the disc on the plate. One or more sealing rings are engaged between the plate and the discs for making an air tight seal between the plate and the disc and for allowing the disc to be firmly and solidly drawn and secured on the holder device, and for allowing the discs to be effectively and precisely painted.

### BACKGROUND OF THE INVENTION

1. Field of the Invention

The present invention relates to a disc painting machine, and more particularly to a disc painting machine for printing or applying patterns or information onto various kinds of discs.

2. Description of the Prior Art

Typical disc printing or painting machines are designed and provided for painting patterns or information onto circular discs, such as the magnetic discs, the floppy discs, the optical discs, the compact discs, and the like. The typical painting machines include a painting member compressed onto the discs one time for painting the patterns or the information onto the discs However, the surfaces of the discs are not even and smooth, such that the discs may not be evenly or effectively painted by the typical disc painting machines in a single compressing and painting process,

The present invention has arisen to mitigate and/or obviate the afore-described disadvantages of the conventional disc painting machines.

### SUMMARY OF THE INVENTION

The primary objective of the present invention is to provide a disc painting machine for precisely painting or applying patterns or information onto the discs.

The other objective of the present invention is to provide a disc painting machine including a holder device for firmly holding and securing the discs to be painted thereon.

The further objective of the present invention is to provide a disc painting machine including an air blowing device for separating the discs that are stacked on the rods and for allowing the discs to be easily fetched and moved to the required positions.

In accordance with one aspect of the invention, there is provided a disc painting machine comprising at least one holder device including a plate having a plurality of orifices formed therein for vacuuming purposes, a disc engaged onto the plate of the holder device, and at least one sealing ring engaged on the plate for engaging with the disc and for making an air tight seal between the plate and the disc and for allowing the disc to be firmly and solidly drawn and secured on the holder device.

The plate includes a bore formed therein, the holder device further includes a second sealing ring engaged on the plate and engaged around the bore of the plate for making the air tight seal between the plate and the disc and between the sealing ring and the second sealing ring.

The holder device includes a housing having an opening formed therein for receiving the plate. The holder device includes a second sealing ring engaged between the housing and the plate for making an air tight seal between the plate and the housing.

The disc painting machine includes a machine body having at least one rod provided thereon, and a plurality of discs supported and stacked on the rod. The rod includes a lateral passage formed therein and directing toward the discs for receiving and directing air to blow and separate the discs from each other. Particularly, the uppermost disc may be blown and separated from the other discs that are supported and stacked on the rod, for allowing the uppermost disc to be easily fetched and moved to the required positions for painting operations.

A rotary platform and a rotary board are further disposed on the machine body and each includes an outer peripheral portion for supporting the holder devices thereon and for supporting the discs on the holder devices while painting the discs.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a disc painting machine in accordance with the present invention;

FIG. 2 is a top plan view illustrating a holder device for supporting the discs; and

FIG. 3 is a cross sectional view taken along lines 3-3 of FIG. 2; and

FIG. 4 is a partial cross sectional view illustrating a rod for holding or supporting or stacking the discs to be painted.

### DETAILED DESCRIPTION OF THE PREFERRED EMBODIMENT

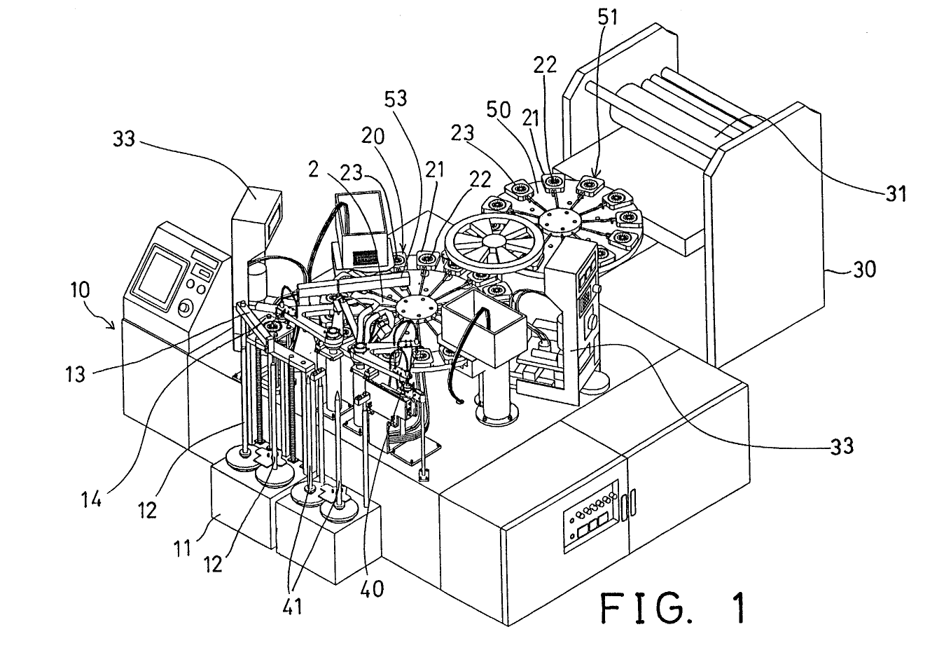

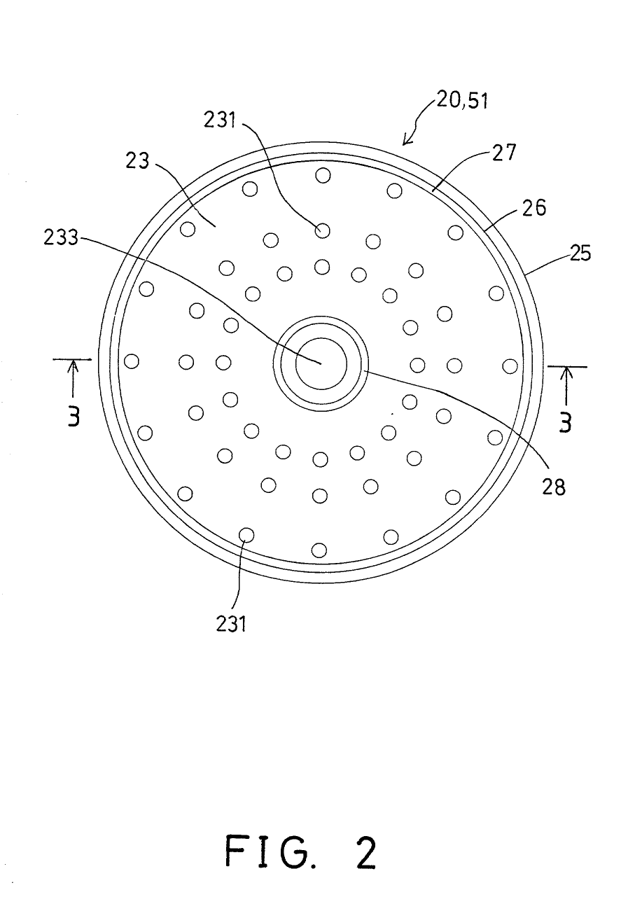

Referring to the drawings, and initially to FIG. 1, a disc painting machine in accordance with the present invention comprises a machine body 10, a table 11 for supporting the discs 70 (FIG. 2) to be painted or treated, such as the magnetic discs, the floppy discs, the optical discs, the compact discs, and the like. One or more rods 12 are disposed and extended upward from the table 11. The discs 70 normally include a hole 71 formed therein for receiving the rods 12 and for allowing the discs 70 to be superposed and stacked and collected on the rods 12 respectively.

A rotary platform 2 is disposed on the machine body 10 and includes a number of holder devices 20 disposed on the outer peripheral portion thereof for receiving and supporting the discs 70 to be painted or treated by the disc painting machine 10. A disc drawing or taking device 13 may be used for taking or fetching the discs 70 stacked on the rods 12 and may move the discs 70 to a desk 14 that is formed or provided on the machine body 10, or may directly move the discs 70 to the holder devices 20 of the rotary platform 2. A painting device 30 may be used or provided for painting or treating the discs 70 that are supported and positioned on the holder devices 20. The platform 2 may be rotated relative to the machine body 10 step by step, for moving the holder devices 20 and thus the discs 70 into or through the painting device 30 step by step or one by one.

After being painted or treated by the painting device 30, the machine body 10 further includes another disc drawing or taking device 40 for taking or fetching the discs 70 that are supported on the holder devices 20 or the rotary platform 2 and that have been painted or treated by the painting device 30, and for moving the discs 70 to the other posts 41 and for allowing the treated discs 70 to be stacked and collected on the posts 41. The above-described disc painting machine is typical and will not be described in further details.

Referring again to FIG. 1, the painting machine further includes a rotary board 50 disposed beside or behind the rotary platform 2. The rotary board 50 also includes a number of holder devices 51 disposed on the outer peripheral portion thereof for receiving and supporting the discs 70 to be painted or treated by the disc painting machine 10. A further disc drawing or taking device 53 is further provided for taking or fetching the discs 70 that are supported on the holder devices 20 of the rotary platform 2 and for moving the discs 70 to the holder devices 51 of the rotary board 50; or for moving the discs 70 to the holder devices 51 of the rotary board 50 to the holder devices 20 of the rotary platform 2.

The disc drawing or taking device 53 may include a telescopic structure or an extendible structure and may also be used for directly taking or fetching the discs 70 that are supported on the holder devices 51 of the rotary board 50 to the posts 41 and for allowing the treated discs 70 to be stacked and collected on the posts 41. The disc drawing or taking device 53 may also be used for directly taking or fetching the discs 70 that are stacked on the rods 12 and may move the discs 70 to the desk 14 provided on the machine body 10, or may directly move the discs 70 from the rods 12 to the holder devices 20 of the rotary platform 2.

It is to be noted that the disc drawing or taking device 13, 14 are good for taking or fetching the discs 70 between the rods 12 and the posts 41 and the holder devices 20 of the rotary platform 2 when only the rotary platform 2 is used or actuated or operated. The painting machine in accordance with the present invention further provide the disc drawing or taking device 53 to move the discs 70 between the rods 12 and the posts 41 and the holder devices 20, 51 of the rotary platform 2 and the rotary board 50.

The painting device 30 includes a painting roller 31 or the like for painting the discs 70 that are supported on the holder devices 51 of the rotary board 50. For example, the painting roller 31 of the painting device 30 may be used for painting or for applying the color patterns on the discs 70 that are supported on the holder devices 51 of the rotary board 50. The painting machine in accordance with the present invention further includes one or more other painting devices 33 disposed beside the rotary platform 2 for painting or for applying the foundation color or the base color on the discs 70 that are supported on the holder devices 20 of the rotary platform 2, and/or may be used for applying or for compressing and/or for adhering an information film or membrane (not shown) onto the discs 70 that are supported on the holder devices 20 of the rotary platform 2. The film or the membrane may be transparent and may include the information of the discs provided therein.

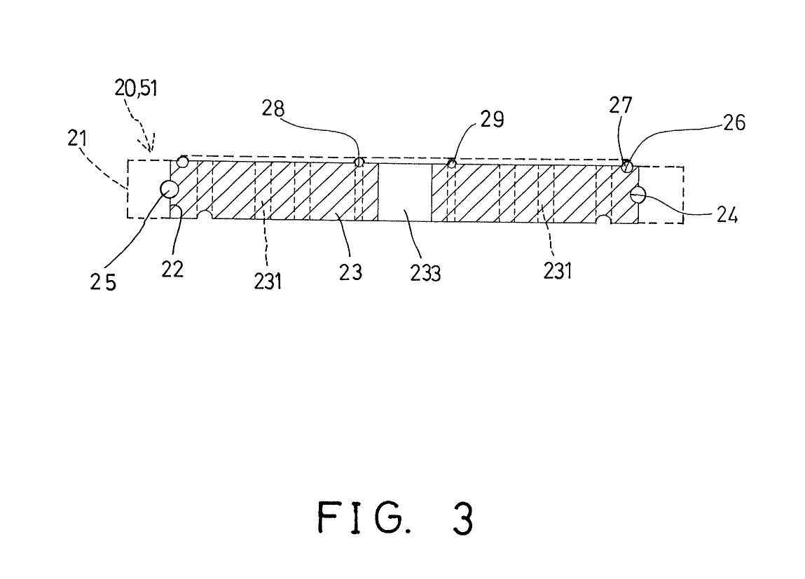

As shown in FIGS. 1-3, the holder devices 20, 51 of the the rotary board 50 and the rotary platform 2 each includes a housing 21 having an opening 22 formed therein for receiving a plate 23 therein. The housings 21 and the respective plates 23 each includes a peripheral recess 24 formed therein for receiving a sealing ring 25 which is engaged between the housing 21 and the plate 23 and which may make a water tight seal or an air tight seal between the housing 21 and the plate 23. The plates 23 each includes a bore 233 formed or provided in the middle or center portion thereof, and each includes a number of orifices 231 formed therein and coupled to the vacuum source (not shown) or the like for drawing or sucking or firmly securing the discs 70 on the holder devices 20, 51 respectively.

The plates 23 each further includes a peripheral groove 26 formed in the upper and outer peripheral portion thereof for receiving a sealing ring 27 therein, and each includes a peripheral slot 28 formed in the upper and middle portion thereof and formed around the bore 233 thereof for receiving another sealing ring 29 therein. The discs 70 will be engaged onto the sealing rings 27, 29, and the sealing rings 27, 29 may make a water tight seal or an air tight seal between the discs 70 and the plate 23 and between the sealing rings 27, 29, such that the discs 70 may be firmly drawn and secured and supported on the plates 23 respectively during the painting operations.

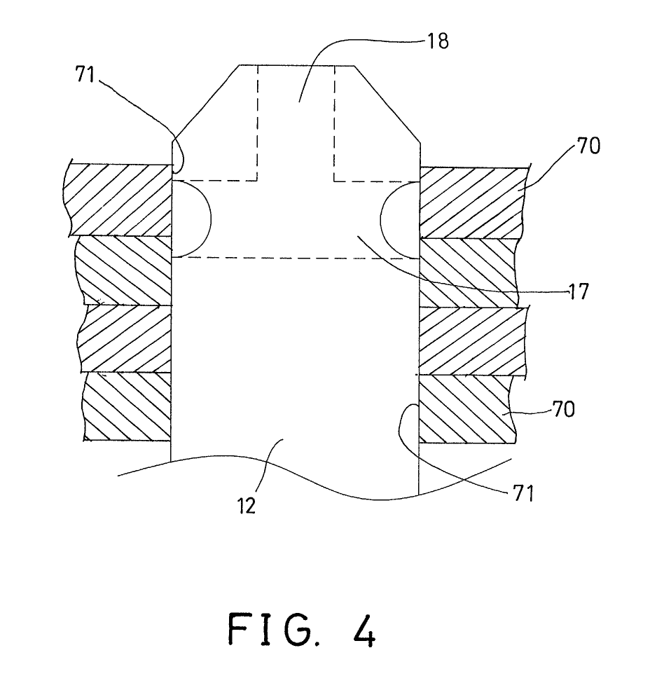

Referring next to FIG. 4, and again to FIG. 1, the rods 12 each includes a lateral passage 17 formed therein and directed or arranged between two superposed or stacked discs 70, and an aperture 18 formed therein and communicating with the lateral passage 17 and coupled to an air source (not shown) or the like, for supplying pressurized air to the lateral passage 17 and for blowing and separating the uppermost disc 70 from the other or the lower discs 70, and for allowing the uppermost disc 70 to be easily fetched or moved to the other positions for painting purposes or operations.

In operation, the disc drawing or taking devices 13, 53, 40 may move the discs 70 between the rods 12 and the posts 41 and the holder devices 20, 51 of the rotary platform 2 and the rotary board 50. The painting devices 33 may first be used for painting or for applying the foundation color or the base color on the discs 70 that are supported on the holder devices 20 of the rotary platform 2, for example. The painting device 30 may then be used for painting or for applying the color patterns on the discs 70 that are supported on the holder devices 51 of the rotary board 50. The painting devices 33 may then be used for applying or for compressing and/or for adhering an information onto the discs 70 that have been moved and supported on the holder devices 20 of the rotary platform 2 again.

Accordingly, the disc painting machine in accordance with the present invention may be used for precisely painting or applying patterns or information onto the discs, and includes a holder device for firmly holding and securing the discs to be painted thereon, and includes an air blowing device for separating the discs that are stacked on the rods and for allowing the discs to be easily fetched and moved to the required positions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A disc painting machine comprising:
at least one holder device including a plate having a plurality of orifices formed therein for vacuuming purposes,
a disc engaged onto said plate of said at least one holder device, and
at least one sealing ring engaged on said plate for engaging with said disc and for making an air tight seal between said plate and said disc.

2. The disc painting machine according to claim 1, wherein said plate includes a bore formed therein, said at least one holder device further includes a second sealing ring engaged on said plate and engaged around said bore of said plate for making the air tight seal between said plate and said disc and between said at least one sealing ring and said second sealing ring.

3. The disc painting machine according to claim 1, wherein said at least one holder device includes a housing having an opening formed therein for receiving said plate.

4. The disc painting machine according to claim 3, wherein said at least one holder device includes a second sealing ring engaged between said housing and said plate for making an air tight seal between said plate and said housing.

5. The disc painting machine according to claim 1, wherein said disc painting machine includes a machine body having at least one rod provided thereon, and a plurality of discs supported and stacked on said at least one rod.

6. The disc painting machine according to claim 5, wherein said at least one rod includes a lateral passage formed therein and directing toward said discs for receiving and directing air to blow and separate said discs from each other.

7. The disc painting machine according to claim 1 further comprising a rotary platform having an outer peripheral portion for supporting said at least one holder device thereon.

8. The disc painting machine according to claim 1 further comprising a rotary board having an outer peripheral portion for supporting said at least one holder device thereon.

9. A disc painting machine comprising:
a machine body,
a rotary platform and a rotary board disposed on said machine body, and each having an outer peripheral portion,
at least one first holder device disposed on said outer peripheral portion of said rotary platform for supporting discs to be painted, and
at least one second holder device disposed on said outer peripheral portion of said rotary board for supporting the discs to be painted.

10. The disc painting machine according to claim 9, wherein said at least one first holder device and said at least one second holder device each includes a plate having a plurality of orifices formed therein for vacuuming purposes.

11. The disc painting machine according to claim 10, wherein said at least one first holder device and said at least one second holder device each includes at least one sealing ring engaged on said plate for engaging with the disc and for making an air tight seal between said plate and said discs.

12. The disc painting machine according to claim 11, wherein said plates each includes a bore formed therein, said at least one first holder device and said at least one second holder device each includes a second sealing ring engaged on said plates and engaged around said bores of said plates for making the air tight seal between said plates and said discs and between said at least one sealing ring and said second sealing ring.

13. The disc painting machine according to claim 9, wherein said at least one first holder device and said at least one second holder device each includes a housing having an opening formed therein for receiving said plates respectively.

14. The disc painting machine according to claim 13, wherein said at least one first holder device and said at least one second holder device each includes a sealing ring engaged between said housing and said plate for making an air tight seal between said plate and said housing.

15. The disc painting machine according to claim 9, wherein said machine body includes at least one rod provided thereon for receiving and stacking the discs on said at least one rod.

16. The disc painting machine according to claim 15, wherein said at least one rod includes a lateral passage formed therein and directing toward said discs for receiving and directing air to blow and separate said discs from each other.
